(19) United States
(12) Patent Application Publication
(10) Pub. No.: US 2013/0174565 A1
(43) Pub. Date: Jul. 11, 2013

(54) METHOD FOR OPERATING A GAS TURBINE

(71) Applicant: ALSTOM Technology Ltd., Baden (CH)

(72) Inventors: Susanne Renate Schell, Baden (CH); Thiemo Meeuwissen, Ennetbaden (CH)

(73) Assignee: ALSTOM TECHNOLOGY LTD., Baden (CH)

(21) Appl. No.: 13/736,980

(22) Filed: Jan. 9, 2013

(30) Foreign Application Priority Data
Jan. 9, 2012 (CH) 00027/12

(51) Int. Cl. F02C 9/40

(52) U.S. Cl. CPC F02C 9/40
USPC 60/772; 60/39.281

(57) ABSTRACT

A method for operating a gas turbine, which is optionally operated with a gaseous fuel (A) having a gaseous mass flow (\dot{m}_{gas})and/or with an oil fuel (B) having an oil mass flow (\dot{m}ₒᵢₗ), wherein a change between an operating mode with gaseous fuel (A) and an operating mode with oil fuel (B) is undertaken during load operation of the gas turbine, and wherein a water addition of a water mass flow (\dot{m}_{H2O}) is provided at least in the operating mode with oil fuel (B). The ratio (Ωₙₒᵣₘ) of the added water mass flow (\dot{m}_{H2O}) to the fuel mass flow during the change between operating modes is determined according to

$${Ω}_{norm} = \frac{{\dot{m}}_{{H}_{2} O} \cdot {LHV}_{norm}}{{\dot{m}}_{gas} \cdot {LHV}_{gas} + {\dot{m}}_{oil} \cdot {LHV}_{oil}} .$$

### CROSS REFERENCE TO RELATED APPLICATIONS

Priority is claimed to Swiss Patent Application No. CH 00027/12, filed on Jan. 9, 2012, the entire disclosure of which is incorporated by reference herein.

### FIELD OF THE INVENTION

The present application relates to a method for operating a gas turbine which is optionally operated with a gaseous fuel, such as natural gas, and/or with a liquid fuel, such as oil, wherein a change between an operation with the gaseous fuel and an operation with the liquid fuel is undertaken during load operation of the gas turbine, and wherein at least the operation with the liquid fuel is carried out with water addition.

### BACKGROUND OF THE INVENTION

It is a sufficiently known measure in the field of modern gas turbine technology to operate the burners of the gas turbine with a gaseous fuel and/or with a liquid fuel. Furthermore, it is known to add water to the fuel flow in the interests of reducing combustion instabilities and for reducing NOx emissions during operation of the gas turbine with liquid fuel. Particular challenges are presented when the operation under load is to be changed over from the one fuel to the other fuel. A qualified controlling of the mass flows of the first fuel, of the second fuel and of the water is an essential precondition for maintaining the operation of the gas turbine during this phase. In the case of a changeover from liquid fuel to gaseous fuel, the mass flow of the first fuel is continuously reduced during a transition phase with simultaneous continuous increase of the feed of gaseous fuel. A reduction of the water feed is required in parallel with this.

According to the solutions of the art, the water feed is controlled on the basis of the oil mass flow based on the ratio Ω. In this case, Ω is defined as the quotient of the mass flows of the water and of the liquid fuel according to the equation

Ω=\dot{m}_{H2O}/\dot{m}ₒᵢₗ (1)

Furthermore, it is known to expand dividend and divisor of this basic equation, especially in dependence upon the design form of the gas turbine with fixed factors for the purpose of determining a normalized ratio Ω. From this follows the equation

Ωₙₒᵣₘ=\dot{m}_{H2O}*LHVₙₒᵣₘ/\dot{m}ₒᵢₗ*LHVₒᵢₗ (2)

It is readily obvious that controlling of the water feed on the basis of equations 1 and 2 is stretched to its limits as oil mass flow decreases. With increasing approximation of the divisor \dot{m}ₒᵢₗ to zero, the equations are undefined. For switching from liquid fuel to gaseous fuel, the aforesaid equations cannot therefore be used as a calculation basis for the water feed, at least during the final phase, since phasewise unfavorable operating parameters would ensue. This interrelationship is obvious.

In the opposite case, that is to say during switching from gaseous fuel to liquid fuel, this problem similarly exists, but in that case in the starting phase with incipient oil feed. As is known, this phenomenon is countered by means of an operating principle which is apparent from FIG. 2, in which the Ω-based operating principle is not maintained during the entire transition phase but only as long as a sufficiently large oil mass flow is fed. After this, a switch is made to another operating control in the form of a step-by-step reduction of the water addition. The limit value, at which a switch is made from the one operating control to the other, customarily lies at a mass flow ratio of about 0.8 between gaseous fuel and liquid fuel. Above this limit value, a step-by-step reduction of the water addition is carried out according to a transfer function up to zero or up to a plant-specific minimum flow.

In this operating regime according to the prior art, it is disadvantageous that certain parameters do not behave continuously during the transition but are subjected to certain discontinuities.

It is therefore an object of the present invention to create a method for operating a gas turbine, which overcomes the disadvantages of the previously referred to prior art and to create an improved operation during the changeover from a liquid fuel to a gaseous fuel and vice versa, which operation is distinguished by a high continuity and without abrupt change of the relevant operating parameters.

### BRIEF SUMMARY OF THE INVENTION

An object of the invention is achieved by a method for operating a gas turbine operated with a gaseous fuel (A), an oil fuel (B), or the gaseous fuel (A) and the oil fuel (B), the method comprising: changing between a first operating mode with the gaseous fuel (A), having a gaseous mass flow (\dot{m}_{gas}), and a second operating mode with oil fuel (B), having an oil mass flow (\dot{m}ₒᵢₗ), during load operation of the gas turbine; adding water, having a water mass flow (\dot{m}_{H2O}), at least in the second operating mode with oil fuel (B); and determining a ratio (Ωₙₒᵣₘ) of the water mass flow (\dot{m}_{H2O}) added to fuel mass flow during the changing between operating modes according to equation 3, below.

The invention includes the technical doctrine that the ratio of the added water mass flow to the fuel mass flow during the transition phase is determined according to the following relationship:

$${Ω}_{norm} = \frac{{\dot{m}}_{{H}_{2} O} \cdot {LHV}_{norm}}{{\dot{m}}_{gas} \cdot {LHV}_{gas} + {\dot{m}}_{oil} \cdot {LHV}_{oil}} . \qquad equation 3$$

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic view of a gas turbine with a gaseous fuel feed, an oil fuel feed and a water feed for operation of said gas turbine,

FIG. 2 shows a graphical representation with a water mass flow ratio which is determined according to the prior art,

FIG. 3 shows a graphical representation with a water mass flow ratio which is determined according to the present invention, and

FIG. 4 shows a view of the mass flows and of the mass flow ratio during the change between two operating modes of the gas turbine.

### DETAILED DESCRIPTION OF THE INVENTION

An aspect of the invention is based in this case on the idea of no longer defining the water mass flow which is to be fed solely on the basis of the equivalent output (\dot{m}ₒᵢₗ* LHVₒᵢₗ [MJ/s]) from the supplied oil mass flow but on the basis of the thermal output which is introduced overall by the two fuels, by a further parameter being additionally incorporated into the divisor of equation 2, specifically the thermal output (\dot{m}_{gas}* LHV_{gas} [MJ/s]) which is introduced by the gaseous fuel.

By means of this measure, the divisor of the equation going to zero and the quotient being therefore undefined is superficially avoided.

A number of advantages are surprisingly associated with controlling the water addition on the basis of equation 3. For one thing, the effect of an excessive water mass flow ensuing towards the end of the transition phase is avoided. For another thing, according to this a changeover to another transfer function is no longer necessary, as is absolutely necessary in the case of the known method on the basis of equation 2, and the definition of a limit value of the fuel mass flow ratio for the transition to the second transfer function is dispensed with.

All this significantly reduces the controlling cost for the operating regime of the fuel change. Furthermore, the continuity of the method is increased.

An aspect of the present invention is also directed towards a gas turbine which can be optionally operated with gaseous fuels or with liquid fuels, and wherein a change between different fuel types during load operation of the gas turbine can be carried out, wherein an addition of water to the fuel is provided at least in the operating mode with liquid fuel, and wherein according to the invention the ratio of the added water mass flow to the fuel mass flow during the change between operating modes is defined according to

$${Ω}_{norm} = \frac{{\dot{m}}_{{H}_{2} O} \cdot {LHV}_{norm}}{{\dot{m}}_{gas} \cdot {LHV}_{gas} + {\dot{m}}_{oil} \cdot {LHV}_{oil}} . \qquad ( equation 3 )$$

In particular, an aspect of the invention is directed towards a control device for controlling the operation of a gas turbine, wherein the control device is designed especially for controlling a water addition for the operation of the gas turbine, wherein the gas turbine can be optionally operated with a gaseous fuel consisting of a gaseous mass flow and/or with an oil fuel consisting of an oil mass flow, wherein a change between an operating mode with gaseous fuel and an operating mode with oil fuel is undertaken during load operation of the gas turbine, and wherein the feed of a water mass flow is provided at least during the operating mode with oil fuel. According to the invention, by means of the control device the ratio (Ωₙₒᵣₘ) of the added water mass flow to the fuel mass flow during the change between the operating modes is determined according to

$${Ω}_{norm} = \frac{{\dot{m}}_{{H}_{2} O} \cdot {LHV}_{norm}}{{\dot{m}}_{gas} \cdot {LHV}_{gas} + {\dot{m}}_{oil} \cdot {LHV}_{oil}} . \qquad ( equation 3 )$$

An aspect of the invention is also directed towards a computer program product for operating a control device of the previously referred to type.

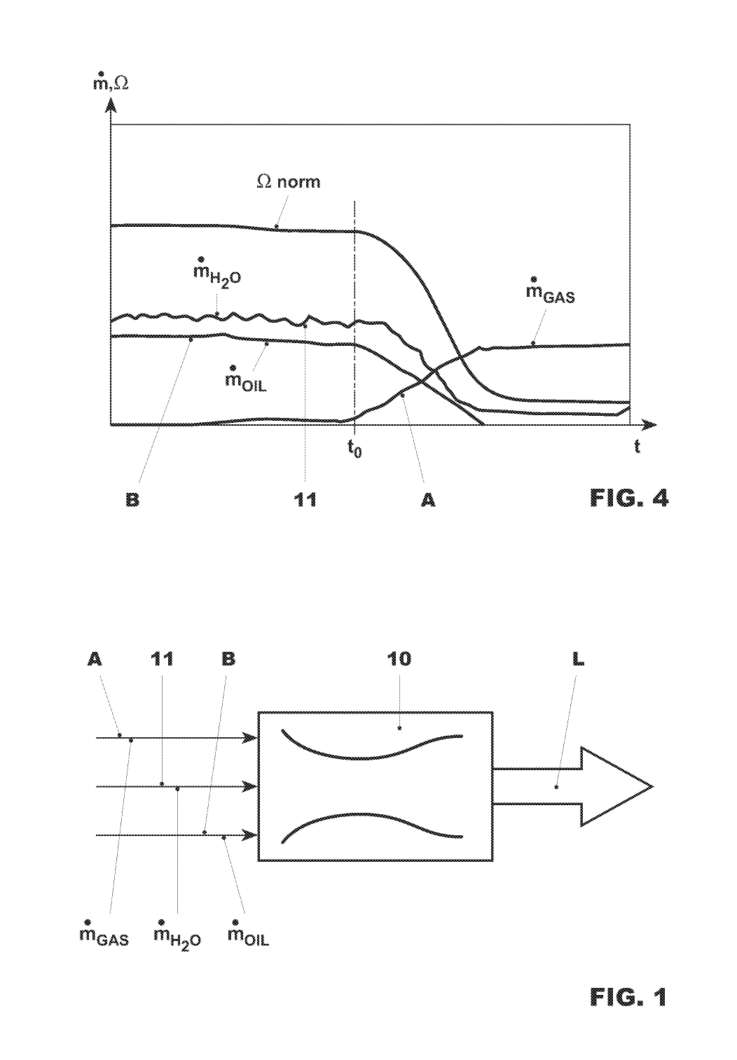

FIG. 1 shows in a schematic view a gas turbine 10 which can be optionally operated with a gaseous fuel A consisting of a gaseous mass flow and/or with an oil fuel B consisting of an oil mass flow. The feed of the gaseous fuel A and of the oil fuel B is indicated schematically. During steady-state operation, the gas turbine 10 is operated preferably either only with gaseous fuel A or only with oil fuel B.

Without significantly altering the turbine output power L of the gas turbine 10, a change of the operating mode can be undertaken during load operation of the turbine. In this case, for example a changeover can be made from operation of the gas turbine 10 with gaseous fuel A to operation of the gas turbine 10 with oil fuel B.

At least during the phase of the change from fuel A to fuel B, but also in conjunction with the steady-state operation of the gas turbine 10 with oil fuel B, a water addition 11 can be provided for operation of the gas turbine 10 so that in addition to the feed of oil fuel B a water mass flow is added to the gas turbine 10. The mass flow of gaseous fuel A is indicated by \dot{m}_{gas} in this case, and the mass flow of oil fuel is indicated by \dot{m}ₒᵢₗ. The water addition is referred to as water mass flow \dot{m}_{H2O}.

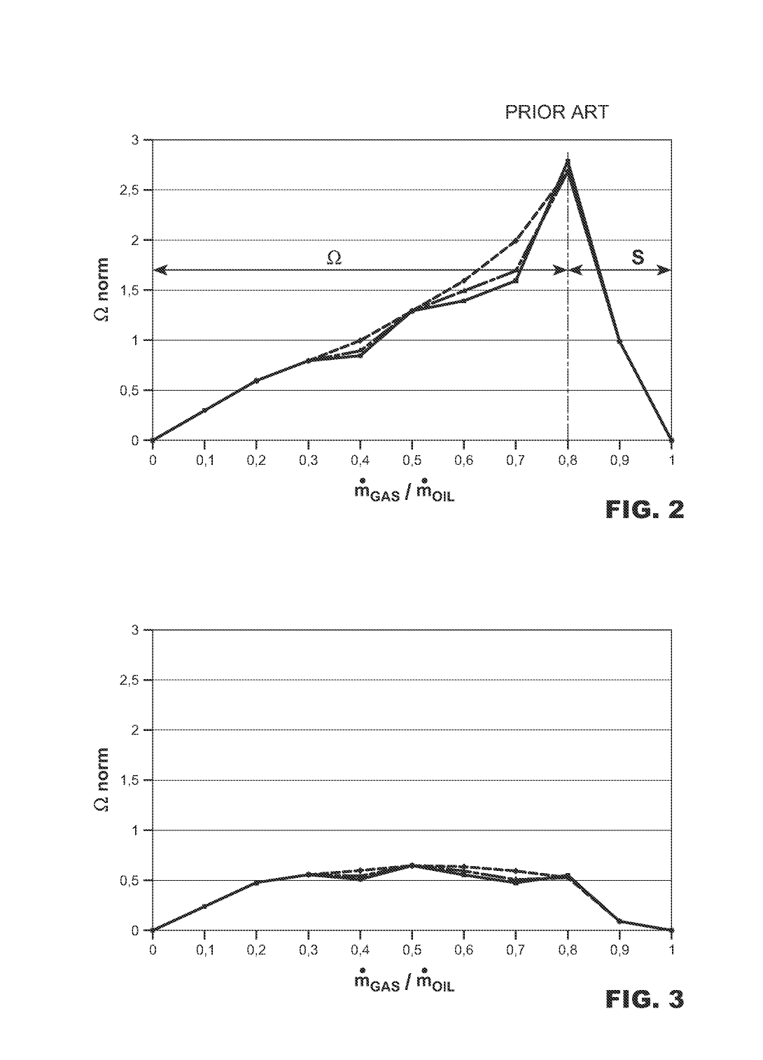

FIG. 2 shows a method for operating a gas turbine 10 with a water mass flow ratio Ω of the added water mass flow \dot{m}_{H2O}, wherein the water mass flow ratio Ωₙₒᵣₘ is determined norm is by equation 2, which reproduces the prior art.

Shown in FIG. 2 is the change from an operating mode of the gas turbine 10 with an oil fuel B to an operating mode of the gas turbine 10 with a gaseous fuel A. The fuel mass ratio \dot{m}_{gas}/\dot{m}ₒᵢₗ is plotted on the abscissa, and the ordinate shows the water mass flow ratio Ω, as is determined from equation 2.

With a fuel mass ratio of 0<=\dot{m}_{gas}/\dot{m}ₒᵢₗ<=0.8, the addition of the water is carried out in a known manner during an Omega-controlled operating mode (Ω). As a result of the diminishing oil mass flow \dot{m}ₒᵢₗ, which is in the denominator of equation 2, the water mass flow \dot{m}_{H2O} steadily increases, and water mass flow ratios Ω of over 2.5 are achieved, as in the case of a fuel mass ratio \dot{m}_{gas}/\dot{m}ₒᵢₗ of 0.8, for example. With a further increase of the fuel mass ratio \dot{m}_{gas}/\dot{m}ₒᵢₗ above 0.8, the volume of injected water would sharply increase according to equation 2 so that the operating mode in the form of the known step-controlled operating mode (S) is undertaken, and the water mass flow is slowly regulated down. As a result, an unfavorable characteristic curve of the water mass flow ratio Ω ensues, especially since the water mass flow can rise sharply during the change from the operating mode with oil fuel B to the operating mode with gaseous fuel A.

FIG. 3 shows the characteristic curve of the water mass flow ratio Ω against the fuel mass ratio \dot{m}_{gas}/\dot{m}ₒᵢₗ, and the water mass flow ratio Ω is determined according to the invention by means of equation 3.

The water mass flow ratio Ω does not rise above the value of 1. Preferably, the water mass flow ratio Ω does not rise above the value of 0.7 and especially not above the value of 0.6. In the depicted operating modes, in which the gas turbine 10 is operated either only with gaseous fuel A or only with oil fuel B, no water addition 11 is carried out, as also shown in FIG. 2 according to the prior art. In this respect, it should be noted that operating modes of gas turbines 10 without water addition 11 are also known. However, water addition 11 is provided if a change between operating modes with gaseous fuel A and oil fuel B is carried out. Consequently, the water mass flow ratio Ω is shown with the value of zero both during an operation which is based only on gaseous fuel A, and the water mass flow ratio Ω has the value of zero if the gas turbine 10 is operated only with oil fuel B.

FIG. 4 finally shows the characteristic curve of the water mass flow ratio Ω as a function of the oil mass flow \dot{m}ₒᵢₗ and of the gaseous mass flow \dot{m}_{gas}. At the time point t₀ of commencement of the changeover, the oil mass flow \dot{m}ₒᵢₗ is reduced and the gaseous mass flow \dot{m}_{gas} is activated. Consequently, at the time point t₀ the oil mass flow \dot{m}ₒᵢₗ decreases and the gaseous mass flow \dot{m}_{gas} increases. The operating mode with oil fuel B is provided with water addition 11, and in the field before the time point t₀, in which the gas turbine 10 is operated with oil fuel B, the water mass flow \dot{m}_{H2O} is approximately constant.

Consequently, a depicted characteristic curve of the water mass flow ratio Ω ensues, having a constant value up to the time point t₀ at which the change of the operating mode from oil fuel B to the operating mode with gaseous fuel A is carried out. The water mass flow ratio Ω therefore continuously decreases so that the water addition 11 can be zero if the gas turbine 10 is operated only with gaseous fuel A.

The invention in its embodiment is not limited to the previously disclosed preferred exemplary embodiment. On the contrary, a number of variants, which make use of the described solution, even with basically different embodiments, are conceivable. All features and/or advantages, including constructional details, spatial arrangements and method steps, which originate from the claims, from the description or from the drawings, may be essential for the invention both separately and in the most diverse combinations.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the attached claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise.

### LIST OF DESIGNATIONS

10 Gas turbine
11 Water addition
A Gaseous fuel
B Oil fuel
L Turbine output power
t₀ Time point of commencement of changeover
106 , Ωₙₒᵣₘ Water mass flow ratio
\dot{m}_{H2O} Water mass flow
\dot{m}ₒᵢₗ mass flow
\dot{m}_{gas} Gaseous mass flow
LHVₒᵢₗ Lower calorific value of oil
LHV_{gas} Lower calorific value of gas
LHVₙₒᵣₘ Normalized calorific value
Ω Omega-controlled operating mode
S Step-controlled operating mode

1. A method for operating a gas turbine operated with a gaseous fuel (A), an oil fuel (B), or the gaseous fuel (A) and the oil fuel (B), the method comprising:
changing between a first operating mode with the gaseous fuel (A), having a gaseous mass flow (\dot{m}_{gas}), and a second operating mode with oil fuel (B), having an oil mass flow (\dot{m}ₒᵢₗ), during load operation of the gas turbine;
adding water, having a water mass flow (\dot{m}_{H2O}), at least in the second operating mode with oil fuel (B); and
determining a ratio (Ωₙₒᵣₘ) the water mass flow (\dot{m}_{H2O}) added to fuel mass flow during the changing between operating modes according to
$${Ω}_{norm} = \frac{{\dot{m}}_{{H}_{2} O} \cdot {LHV}_{norm}}{{\dot{m}}_{gas} \cdot {LHV}_{gas} + {\dot{m}}_{oil} \cdot {LHV}_{oil}} .$$

2. The method of claim 1, wherein a water mass flow ratio (Ωₙₒᵣₘ) is provided during a change from the first operating mode with gaseous fuel (A) to the second operating mode with oil fuel (B).

3. The method of claim 1, wherein a water mass flow ratio (Ωₙₒᵣₘ) is provided during a change from the second operating mode with oil fuel (B) to the first operating mode with gaseous fuel (A).

4. The method of claim 2, wherein the change from the first operating mode to the second operating mode comprises activating the water mass flow (\dot{m}_{H2O}) before feeding the oil mass flow (\dot{m}ₒᵢₗ).

5. The method of claim 3, wherein the change from the second operating mode to the first operating mode comprises activating the water mass flow (\dot{m}_{H2O}) feeding the gaseous mass flow (\dot{m}_{gas}).

6. The method of claim 1, wherein the gas turbine includes a guide vane arrangement,
wherein a position of a guide vane of the guide vane arrangement remains unchanged during a change between first the operating mode and the second operating mode.

7. The method of claim 1, wherein the gas turbine in the second operating mode is configured to be operated without addition of the water mass flow (\dot{m}_{H2O}), and
wherein the adding of the water mass flow (\dot{m}_{H2O}) is activated for changing between the first operating mode and the second operating mode.

8. The method of claim 1, wherein a water mass flow ratio (Ωₙₒᵣₘ) during a change from the first operating mode to the second operating mode has a maximum value of 1.

9. A gas turbine, comprising:
a guide vane arrangement,
wherein the gas turbine is configured to be operated with a gaseous fuel (A) having a gaseous mass flow (\dot{m}_{gas}), with an oil fuel (B) having an oil mass flow (\dot{m}ₒᵢₗ), of with the gaseous fuel (A) and the oil fuel (B),
wherein the gas turbine is configured such that a change between a first operating mode with gaseous fuel (A) and a second operating mode with oil fuel (B) can be carried out during load operation of the gas turbine,
wherein a water addition of a water mass flow (\dot{m}_{H2O}) is provided at least in the operating mode with oil fuel (B), and
wherein a ratio (Ωₙₒᵣₘ) of the water mass flow (\dot{m}_{H2O}) added to a fuel mass flow during a change between operating modes is determined according to
$${Ω}_{norm} = \frac{{\dot{m}}_{{H}_{2} O} \cdot {LHV}_{norm}}{{\dot{m}}_{gas} \cdot {LHV}_{gas} + {\dot{m}}_{oil} \cdot {LHV}_{oil}} .$$

10. A control device for controlling an operation of a gas turbine, configured to control a water addition for operating the gas turbine,
wherein the gas turbine can be optionally operated with a gaseous fuel (A) having a gaseous mass flow (\dot{m}_{gas}), with an oil fuel (B) having an oil mass flow (\dot{m}ₒᵢₗ), or with the gaseous fuel (A) and the oil fuel (B),
wherein a change between a first operating mode with gaseous fuel (A) and a second operating mode with oil fuel (B) is undertaken during load operation of the gas turbine,
wherein water, having a water mass flow (\dot{m}_{H2O}), is added at least in the second operating mode,
wherein the control device is configured to determine a ratio (Ωₙₒᵣₘ) of the water mass flow (\dot{m}_{H2O}) added to the fuel mass flow (\dot{m}ₒᵢₗ) during a change between operating modes according to
$${Ω}_{norm} = \frac{{\dot{m}}_{{H}_{2} O} \cdot {LHV}_{norm}}{{\dot{m}}_{gas} \cdot {LHV}_{gas} + {\dot{m}}_{oil} \cdot {LHV}_{oil}} .$$

11. A non-transitory computer-readable medium containing computer-executable instructions for operating a gas turbine operated with the gaseous fuel (A), the oil fuel (B), or the gaseous fuel (A) and the oil fuel (B) with the control device of claim 10, wherein execution of the computer-executable instructions by a processor causes the the following steps to be performed:
changing between the first operating mode with the gaseous fuel (A), having the gaseous mass flow (\dot{m}_{gas}), and the second operating mode with oil fuel (B), having the oil mass flow (\dot{m}ₒᵢₗ), during load operation of the gas turbine;
adding water, having the water mass flow (\dot{m}_{H2O}), at least in the second operating mode with oil fuel (B); and
determining the ratio (Ωₙₒᵣₘ) the water mass flow (\dot{m}_{H2O}) added to fuel mass flow during the changing between operating modes according to
$${Ω}_{norm} = \frac{{\dot{m}}_{{H}_{2} O} \cdot {LHV}_{norm}}{{\dot{m}}_{gas} \cdot {LHV}_{gas} + {\dot{m}}_{oil} \cdot {LHV}_{oil}} ,$$
wherein the control device effects the determining and the adding.

12. The method of claim 1, wherein a water mass flow ratio (Ωₙₒᵣₘ) during a change from the first operating mode to the second operating mode has a maximum value of 0.7.

13. The method of claim 1, wherein a water mass flow ratio (Ωₙₒᵣₘ) during a change from the first operating mode to the second operating mode has a maximum value of 0.6.
